(19) United States
(12) Patent Application Publication
(10) Pub. No.: US 2017/0304890 A1
(43) Pub. Date: Oct. 26, 2017

(54) CERAMIC REFRACTORY COATINGS

(71) Applicant: Prince Minerals LLC, Houston, TX (US)

(72) Inventors: Jeffrey J. Cieplewski, Houston, TX (US); Phillip J. Aliota, Houston, TX (US); James Collin Britt, Houston, TX (US); Jacqueline J. Smith, Houston, TX (US)

(73) Assignee: Prince Minerals LLC, Houston, TX (US)

(21) Appl. No.: 15/415,239

(22) Filed: Jan. 25, 2017

Related U.S. Application Data
(60) Provisional application No. 62/326,354, filed on Apr. 22, 2016.

(51) Int. Cl. B22D 13/10; B22C 3/00; C04B 35/622; C04B 35/107

(52) U.S. Cl. CPC B22D 13/102; B22D 13/108; C04B 35/107; C04B 35/62222; B22C 3/00; C04B 2235/3232; C04B 2235/3208; C04B 2235/3201; C04B 2235/3272; C04B 2235/3281; C04B 2235/3418; C04B 2235/425; C04B 2235/3217

(57) ABSTRACT

Disclosed herein are refractory coating compositions with improved drying times, defect prevention, and gas permeability and methods for using such refractory coating compositions.

### BACKGROUND

Refractory coatings are designed to evenly coat various foundry casting substrates, providing them with a uniform protective layer capable of withstanding the high temperatures of the molten metals involved in the casting of various alloys—aluminum, iron, copper, brass, bronze, and steel parts for a variety of industries. Specifically, refractory coatings are suspensions of a mineral or refractory compound in a carrier liquid that may be applied to a variety of substrates, such as a substrate composed of a granular media (e.g. quartz sand) that has been either inorganically or organically bound into a pre-determined shape. After application of the refractory coating, the carrier liquid is removed and the mineral or refractory compound is retained as a layer on the substrate surface.

A properly applied refractory coating can perform a variety of functions during an industrial casting operation. For example, the refractory coating can prevent or minimize molten metal penetration into the substrate during casting processes, thereby preventing or minimizing “burn-on” and/or the erosion of the substrate by the molten metal, among other defects commonly seen in casting processes. By reducing these defects, refractory coatings can improve the quality of the cast member by imparting a smoother surface finish, reducing scrap, and lowering cleaning/finishing costs that are sometimes necessary to address defects that form during molten metal casting processes.

Accordingly, refractory coating compositions capable of improving molten metal casting processes are sought after industrially.

### SUMMARY

This summary is provided to introduce a selection of concepts that are further explained in the detailed description below. This summary is not intended to identify key or essential features of the claimed subject matter, nor is it intended to be used as an aid in limiting the scope of the claimed subject matter.

In one aspect, embodiments disclosed herein relate to a refractory coating composition. The refractory coating composition may include a carrier liquid and solid ceramic beads. In some embodiments, the solid ceramic beads may have a D₉₅ value in the range from about 75 microns to 150 microns, a D₅₀ value in the range from about 35 microns to 50 microns, and a D₁₀ value in the range from about 5 microns to 15 microns.

The ceramic beads may be formed from one or more of alumina, silica, magnesia, zirconia, calcium oxide, tungsten carbide, boron nitride, and/or hafnium carbide. In some embodiments, the ceramic beads may comprise, consist of, or consist essentially of fused alumina. For example, fused alumina according to embodiments herein may refer to compositions having: about 50-85% by weight alumina; about 5-30% by weight silica; about 1-15% by weight titania; and about 1-12% by weight iron oxide (Fe₂O₃); wherein a total of the amount is 100% by weight. Fused alumina compositions according to some embodiments herein may further include: about 0.1-5% by weight potassium oxide; about 0.05-2% by weight calcium oxide; and about 0.05-1.5% by weight copper oxide (CuO).

The ceramic beads of the coating composition preferably do not sinter or melt at temperatures below about 1500° C. The ceramic beads may further have a hardness of at least 7 on the Mohs scale and/or a pH value between about 6.5 and 7.5.

The coating compositions may include, for example: 30-80% by weight ceramic beads; and 15-45% by weight carrier fluid. The coating compositions may further include, in some embodiments, one or more of rheological modifiers, viscosifiers, chelating agents, dispersants, binders, foam control agents, a carbon additive, surfactants, wetting agents, and/or preservatives.

In another aspect, embodiments disclosed herein relate to a refractory coating composition. The refractory coating composition may include: a carrier liquid; and about 40-80% by weight ceramic beads.

In another aspect, embodiments disclosed herein relate to a refractory coating composition. The refractory coating composition may include: 15-45% by weight carrier fluid; 30-80% by weight solid ceramic beads; 2.5-12% by weight graphite; 0.25-6% by weight clay; and 0.1-1% binder.

In another aspect, embodiments disclosed herein relate to a method of coating a substrate with a refractory coating composition. For example, substrates that may be coated with a refractory coating composition may include metal molds, lost foam molds, sand molds, compacted graphite molds, permanent molds, or any other substrates known to be coated with a refractory coating composition during foundry operations. The method may include applying one of the above described refractory coating compositions to a substrate; and drying the refractory coating composition. The method may further include diluting the refractory coating composition. In some embodiments, the drying takes at least 5% less time than a comparable traditional refractory coating composition.

In another aspect, embodiments disclosed herein relate to a method of casting a metal. The method may include: forming and binding a substrate; coating the substrate with a refractory coating composition as described above; drying the refractory coating composition onto the substrate to form a coated substrate; casting a molten metal onto the coated substrate; and separating a metal casting from the coated substrate.

In another aspect, embodiments disclosed herein relate to a method of centrifugally casting a metal. The method may include coating the interior of a centrifugal mold with a refractory coating composition. The refractory coating composition may include: a carrier liquid; and about 60-80% by weight ceramic beads. The method may further include: drying the refractory coating composition onto the centrifugal mold; centrifugally casting a molten metal into the centrifugal mold body; and separating a metal casting from the centrifugal mold body.

Other aspects and advantages of the claimed subject matter will be apparent from the following description and the appended claims.

### BRIEF DESCRIPTION OF DRAWINGS

FIG. 1 is a scanning electron microscope (SEM) image of ceramic beads according to one or more embodiments of the present disclosure.

FIG. 2 is a scanning electron microscope (SEM) image of ceramic beads according to one or more embodiments of the present disclosure.

FIG. 3 shows a plot of the drying time for the coatings presented in the Examples at 250° F. and the three different airflow levels.

FIG. 4 shows a plot of the drying time for the coatings presented in the Examples at 350° F. and the three different airflow levels.

FIG. 5 shows a plot of the drying time for the coatings presented in the Examples at 450° F. and the three different airflow levels.

FIG. 6 shows the drying rate results for the coatings presented in the Examples.

FIG. 7 shows a bar graph comparing the rate of weight loss as a function of temperature and airflow for Comp. Ex. 1.

FIG. 8 shows a bar graph comparing the rate of weight loss as a function of temperature and airflow for Ex. 1.

FIG. 9 shows a bar graph comparing the percent decrease in drying time for Ex. 1 when compared to Comp. Ex. 1 as a function of temperature and airflow.

### DETAILED DESCRIPTION

In one aspect, embodiments disclosed herein generally relate to refractory coating compositions with improved drying times, defect prevention, and gas permeability. In more particular aspects, embodiments disclosed herein relate to refractory coating compositions that include ceramic beads that are spherical, solid, and made from refractory materials.

Many conventional refractory coating compositions include significant quantities of flake- or plate-like particles of refractory materials (e.g., talc, mica, calcined kaolin, etc.) to impart high-temperature stability to the refractory coating, which is needed to protect the substrate from encountering molten metal during the casting process. Specifically, the traditional flake- or plate-like refractory particles have essentially a two-dimensional morphology with two dimensions that are considerably larger than a third dimension. Because of this morphology, the traditional refractory particles tend to lay flat, overlap, and layer when coated and dried upon the substrate, with their smallest dimension essentially perpendicular to the surface of the substrate.

Thus, while the flake- or plate-like refractory particles provide the necessary high temperature stability to protect the substrate from burn-on defects or erosion during the casting process, the overlap and layering of the particles due to their shape tends to minimize the void space within the coating and reduce the gas permeability of the refractory coating. The gas permeability of refractory coating compositions is an important consideration for two reasons: (1) a higher gas permeability can reduce the time required to dry a refractory coating composition onto a substrate and (2) in order to maintain the desired shape, the granulated base materials that make up the molds are commonly bound together using organic resins prior to being coated with the refractory coating composition, and during the casting process the organic resins pyrolyze and otherwise decompose under the high temperatures of the molten metal, releasing gases that need to be liberated from the substrate through the refractory coating in order to prevent gas defects and/or the scaling off of the refractory coating due to the generation of high internal pressures.

In one or more embodiments, refractory coating compositions of the present disclosure may comprise ceramic beads that possess a high degree of sphericity and roundness. In one or more embodiments, the ceramic beads may have substantially smooth surfaces with low degrees of surface roughness. For example, the ceramic beads may have a sphericity of greater than 0.9 and a roundness of greater than 0.9 in some embodiments; in other embodiments, the ceramic beads may have a sphericity of about 1.0 and/or a coefficient of angularity of less than 1.1. Thus, the ceramic beads may be visualized as geometrical spheres and have a surface area roughly equating to 4πr², where r is equivalent to the radius of the bead.

In one or more embodiments, the ceramic beads may be solid. That is to say, the ceramic beads may be bodies that are substantially free from cavities or voids within their structure. In one or more embodiments, the ceramic beads may have a D₉₅ value (i.e., the diameter at which 95% of the sample's mass is comprised of smaller particles) of about 150 microns, or about 125 microns, or about 100 microns, or about 75 microns. In one or more embodiments, the ceramic beads may have a D₅₀ of about 50 microns, or about 45 microns, or about 40 microns, or about 35 microns. In one or more embodiments, the ceramic beads may have a D₁₀ of about 5 microns, or about 10 microns, or about 15 microns. In one or more embodiments, the permeability of the refractory coating may be decreased as the size of the ceramic beads is decreased and/or as the thickness of the refractory coating is increased. This effect can be rationalized by understanding that as the beads decrease in size, the void space between them when they are packed decreases, thereby creating a more tortuous path for gases to permeate the coating, while a thicker coating also creates a more tortuous path for gases to permeate the coating. Thus, the thickness of the coating and the size of ceramic beads need to be balanced and both within a range so that the void space in the coating is small and tortuous enough that it prevents the ingress of the molten metal (a high viscosity liquid) through the refractory coating, while also being large enough to allow the egress of gases out of the substrate to avoid gas defects in the casting.

In one or more embodiments, the ceramic beads may be made from primarily refractory materials, with refractory materials being non-metallic materials having chemical and physical properties such that they retain their strength and shape at high temperature conditions, including temperatures above about 1000° C. in some instances. As a result of being made of primarily refractory materials, ceramic beads of the present disclosure have a low coefficient of thermal expansion and high sintering and melting temperatures. For example, the ceramic beads may not sinter or undergo a glass transition at temperatures below about 1500° C., or about 1550° C., or about 1600° C., or about 1650° C., or about 1700° C., or about 1750° C., or about 1800° C., or about 1850° C. Thus, the refractory coatings containing ceramic beads, as disclosed herein, may be useful as refractory coatings for casting processes for iron alloys, which are conventionally cast at 1340-1490° C., and steel alloys, which are conventionally cast at 1510-1760° C.

In one or more embodiments, the ceramic beads may comprise at least one of alumina, silica, magnesia, zirconia, calcium oxide (lime), tungsten carbide, boron nitride, and hafnium carbide. In one or more embodiments, the ceramic beads consist essentially of a fused alumina material.

In one or more embodiments, the ceramic beads may include about 50-85% by weight alumina, or about 55-80% by weight alumina, or about 60-75% by weight alumina. In one or more embodiments, the ceramic beads may include about 5-30% by weight silica, or about 10-25% by weight silica, or about 15-20% by weight silica. In one or more embodiments, the ceramic beads may include about 1-15% by weight titania, or about 2.5-12.5% titania, or about 4.5-10% titania. In one or more embodiments, the ceramic beads may include about 1-12% by weight iron oxide (Fe₂O₃), or about 1.5% to 10% by weight iron oxide, or about 2% to 8% iron oxide. In one or more embodiments, the ceramic beads may include about 0.1-5% by weight potassium oxide, or about 0.25 to 4% by weight potassium oxide, or about 0.5% to 3% by weight potassium oxide. In one or more embodiments, the ceramic beads may include about 0.05-2% by weight calcium oxide, or about 0.075-1.75% by weight calcium oxide, or about 0.1-1.5% by weight calcium oxide. In one or more embodiments, the ceramic beads may include about 0.05-1.5% by weight copper oxide (CuO), or about 0.075-1.25% by weight copper oxide, or about 0.1-1% copper oxide. A fused alumina material, as used herein, may comprise at least the alumina, silica, titania, and iron oxide (Fe₂O₃) components indicated above.

In one or more embodiments, the ceramic beads may have a hardness of at least 7 on the Mohs scale and a strong resistance to crushing (i.e., a high compressive strength). For example, the ceramic beads may have a crush resistance such that less than 10% of the particles break into fines at a pressure of 56 MPa; less than 8% break into fines at a pressure of 56 MPa in other embodiments.

In one or more embodiments, the ceramic beads may have a pH value of about 6.5-7.5. The roughly neutral pH value of the ceramic beads provides a couple of advantages including: (1) makes the overall coating composition compatible towards the organic compounds therein (e.g., resins, binders, rheological modifiers, etc.), which reduces unintended reactions of the components and extends the composition shelf life and (2) makes the coating composition compatible with substantially all of the metals and alloys (e.g., non-ferrous alloys, iron alloys, and steels) that may be cast onto substrates having the refractory coating compositions thereon, which reduces pitting and other surface defects that may arise when an acidic or alkaline refractory material is in contact with a metal surface.

In one or more embodiments, the amount of ceramic beads in the refractory coating composition may be from about 30-80% by weight, or from about 35-75% by weight, or from about 40-70% by weight, or from about 45-65% by weight, or from about 50-60% by weight. Further, in one or more embodiments, the ceramic beads may be substantially the only refractory material within the refractory coating composition. In other embodiments, the ceramic beads may not be the only refractory material within the refractory coating composition. For example, the refractory coating composition may include one or more traditional refractory materials including graphite, zirconia, talc, mica, kaolin, pyrophyllite, ball clays, etc.

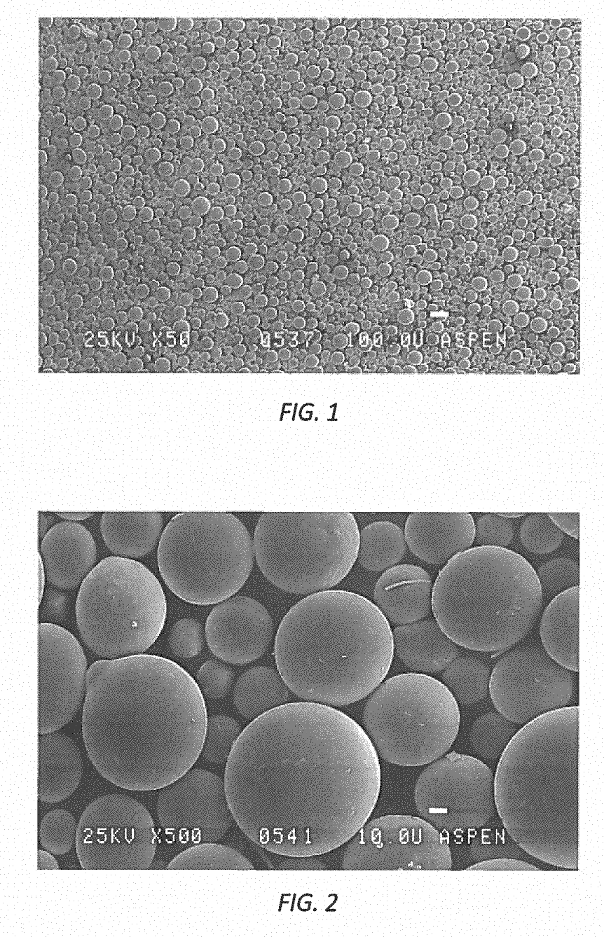

FIGS. 1 and 2 show scanning electron microscope (SEM) images, at two different magnifications, of ceramic beads according to one or more embodiments of the disclosure. FIG. 1 is a less magnified image than FIG. 2, with the white scale bar in the lower right quadrant equating to 100 microns. FIG. 2 presents a more magnified image than FIG. 1, with the white scale bar in the lower right quadrant equating to 10 microns. As can be seen in both images, the ceramic beads are spherical solids with relatively smooth surfaces and generally consistent sizes.

In addition to the ceramic beads described above, refractory coating compositions of the present disclosure may contain a plurality of other constituents. For example, a refractory coating composition contains a carrier liquid and may further contain at least one of rheological modifiers, viscosifiers, chelating agents, dispersants, inorganic or organic binders, foam control agents, a carbon additive, surfactants, wetting agents, and preservatives. Specific additives within each class and the possible amounts that they may be used within the refractory coating composition will be generally determinable to those of skill in art.

In one or more embodiments, the carrier liquid of the refractory coating composition may be water. In one or more embodiments, the carrier liquid may be about 15-45% by weight, or from about 20-40% by weight, of the refractory coating composition.

In one or more embodiments, bentonite clay and/or attapulgite clay may be used as a rheological modifier or viscosifier for a refractory coating composition. By acting as a viscosifier and modifying the rheology of the refractory coating composition, the clays may help to generate a suspension of the solids within the composition and allow for even deposition of the coating on a substrate surface. In one or more embodiments, clays may account for about 0.25-6% by weight, or from about 0.5-4.5% by weight, or from about 0.75-3.5% by weight, or from greater than zero to about 0.25% or 0.5% by weight of the refractory coating composition.

In one or more embodiments, the refractory coating composition may include a carbon additive, which may be graphite. A carbon additive may be used in refractory coating compositions to provide the casting with improved “peel” characteristics. Additionally, a carbon additive may also generate a reducing atmosphere in the substrate during the casting. In these embodiments, the graphite or other carbon additive may be included in the refractory coating composition in amounts of about 2.5-12% by weight, or from about 4.5-11% by weight, or from about 6-10% by weight.

In one or more embodiments, an organic binder, such as dextrin, may be added to the refractory coating composition to increase adhesion of the composition to the substrate as well as to provide a dense and uniform coating of solid particles on the substrate once dried. In these embodiments, organic binders may be added in amounts of about 0.25-1% by weight, or from about 0.3-0.95% by weight, or from about 0.35-0.9% by weight of the composition. In one or more embodiments, an inorganic binder may be added to the refractory coating composition. In these embodiments, the inorganic binder may be sodium silicate and may be added in amounts of about 0.01-1% by weight, or from about 0.1-0.95% by weight, or from about 0.15-0.9% by weight of the composition.

Table 1 illustrates the components of a refractory coating composition according to one or more embodiments of the present disclosure. The refractory coating composition shown in Table 1 may be formulated so that total weight percent of the listed components is 100 weight %, or, without departing from the scope of this disclosure, other components not listed in the table may be added to the listed components to further refine the properties and functionality of the refractory coating composition.

TABLE 1

| | Embodiment 1 | Embodiment 2 | Embodiment 3 |
|---|---|---|---|
| Component | Amount (wt %) | Amount (wt. %) | Amount (wt %) |
| Ceramic Beads | 25-85 | 30-80 | 30-80 |
| Carrier Liquid | 15-55 | 15-45 | 25-45 |
| Clay Viscosifier | 0-6 | 0.01-3 | 0-0.1 |
| Carbon Additive | 0-12 | 0.01-6 | 0-0.1 |
| Binder | 0-2 | 0.1-1 | 0.1-1 |

In some particular embodiments, the amount of ceramic beads in the refractory coating composition may be from about 50-80% by weight, or from about 55-75% by weight, or from about 60 to 70% by weight. For example, higher amounts of ceramic beads may be useful during a centrifugal casting operation, in which a permanent substrate/mold is rotated continuously about its axis at high speeds (300 to 3000 rpm) as the molten metal is poured. The molten metal is centrifugally thrown towards the inside mold wall, where it solidifies after cooling. The relatively higher amounts of spherical ceramic beads used in the refractory coating compositions used to coat the interior walls of the mold may improve the release characteristics of casted lengths of pipe or other parts, as their spherical shape may facilitate the “rolling” and separation of the casting from within the mold. Additionally, the coating compositions containing spherical ceramic beads may more effectively adhere to the permanent molds used in centrifugal casting and thereby be used during more casting processes before a new application of refractory coating is required for effective casting. The increased permeability may also serve to extend the life of the mold by effectively dissipating heat and otherwise protecting the mold from damage during the casting process. These advantages decrease operating costs for the foundry and thereby provide significant benefits to operators.

A refractory coating composition which may be used for centrifugal casting processes may include about 50-80% by weight ceramic beads of the present disclosure, about 20-50% by weight carrier fluid, and about 0.01-1% by weight inorganic binder.

A skilled artisan will understand that the presence and amounts of the components of the refractory coating composition may be tailored to achieve a desired rheological profile for each particular application. For example, refractory coating compositions can be applied to substrates by a variety of different methods, whether by spraying, brushing, dipping, etc., with each application technique benefiting from a coating composition having a particular rheological profile. Additionally, skilled artisans will understand that refractory coating compositions are often supplied to foundries by suppliers in a concentrated state, which the foundry may dilute with further carrier liquid (e.g., water) prior to applying it to substrates. Regardless of the application method, once applied to a bound granulated substrate the ceramic beads may penetrate two to three grains into the substrate and because the round beads are not flake or plate-like they do not lay flat and significantly overlap each other on the surface of the substrate, thereby increasing the gas permeability of the coating by increasing the void space between the refractory materials, thereby creating a less tortuous path for the escape of gases through the dried coating. Indeed, even when traditional flake or plate-like refractories are included in coating compositions of the present disclosure, the presence of the ceramic beads may serve to effectively reduce overlap of the traditional refractories and increase the gas permeability of the coating.

In one or more embodiments, the thickness of a dried refractory coating according to the present disclosure may be from about 0.5 mm to 9 mm thick, depending upon the application method and the amount of applications that take place. For example, one application of a refractory coating composition of the present disclosure by spray coating may create a refractory coating with a thickness on a substrate of about 0.5 mm to 2.5 mm thick, while one application via dip coating may create a refractory coating with a thickness on a substrate of about 3 to 9 mm thick. In one or more embodiments, multiple applications of the refractory coating composition may occur, which would in turn increase the thickness of the overall coating proportional to those discussed above. The difference in thickness may affect the gas permeability and drying time for the refractory coating as a thicker coating may have a lower gas permeability and longer drying time than a thinner coating.

Drying the refractory coating compositions onto the substrate is often a rate-limiting step for the amount of parts that may be casted by a foundry in a given period of time. Therefore, decreasing the amount of time spent drying the refractory composition on the substrates may increase foundry productivity and efficiency. As mentioned above, a skilled artisan will understand that the drying time for the substrate will depend on the specific properties of the coating composition that is being applied and on the actual method of drying the coating composition onto the substrate. In general, increasing the gas permeability of the coating allows for faster drying of the coating on the substrate and increased gas release during the molten metal casting process. In one or more embodiments, when dried under similar conditions, substrates coated with refractory coating compositions of the present disclosure may be dried in at least about 5% less time, or at least about 10% less time, or at least about 15% less time, or at least 20% less time, or at least 30% less time, or at least 35% less time than substrates coated with a comparable (i.e., similar viscosity, rheology, water content, refractory content, etc.) traditional refractory coating composition that does not include ceramic beads according to the present disclosure.

Once the coatings are dried on the substrates they may be used during a molten metal casting process for the production of iron or steel articles, along with other metals or alloys (e.g., aluminum, brass, bronze, copper, etc.) as long as their processing temperatures are below the glass transition of the refractory materials used in the refractory coating composition. For example, a method of coating a substrate with a refractory coating composition may include applying a refractory coating composition according to the present disclosure to a substrate; and drying the refractory coating composition onto the substrate. A method of casting a metal/alloy may include forming and binding a substrate body; coating the substrate body with a refractory coating composition according the present disclosure; drying the refractory coating composition onto the substrate body to form a coated substrate body; casting a molten metal/alloy onto the coated substrate body; and separating a metal/alloy casting from the coated substrate body. A method of centrifugally casting a metal/alloy may include coating the interior of a centrifugal mold with a refractory coating composition that includes a carrier liquid; and about 60-80% by weight ceramic beads; drying the refractory coating composition onto the centrifugal mold; centrifugally casting a molten metal onto the centrifugal mold body; and separating a metal casting from the centrifugal mold body.

Temperatures during metal, iron alloy, non-ferrous alloy and/or steel alloy casting processes may approach 1300° C.-1800° C. and the organic resins applied to bind the granulated substrates together are pyrolyzed or otherwise decomposed producing gaseous products that can be more readily vented through the ceramic bead containing refractory coating due to its increased permeability when compared to refractory coating compositions that contain traditional flake or plate-like refractory materials. Furthermore, because the ceramic beads have low coefficient of thermal expansion and high melting points the possibility for the coating to crack or otherwise fail is reduced. In this way, burn-on, veining, and other defects are greatly reduced when compared to conventional refractory coating compositions, resulting in the formation of smooth casted surfaces with excellent release characteristics and minimal cleaning/finishing requirements.

### Examples

Two refractory coating compositions were prepared, a composition according to the present disclosure (Ex. 1) and a comparative composition (Comp. Ex. 1) not according to the present disclosure. These compositions were subjected to testing, as will be described below. Comp. Ex. 1 is a conventional refractory coating, including traditionally used refractory materials that have plate-like morphologies. Ex. 1 is a refractory coating according to the present disclosure (i.e., including an amount of solid ceramic beads therein). In each of the coating compositions, the refractory materials (e.g. the traditional materials of Comp. Ex. 1 and the solid ceramic beads of Ex. 1) make up the majority of the percent solids indicated in Table 2 below. A small portion of the percent solids is clay viscosifier, carbon additive, binder material, and other additives. The remaining weight percent is primarily carrier fluid, which was water in both compositions.

Additionally, tests were conducted to evaluate the drying time of coated phenolic urethane cold-box cores. Two variables were modulated in these tests, namely drying temperature and air flow rate. Three degrees of air flow rate were tested: low (3.19 cubic feet per minute), medium (11.95 cubic feet per minute), and high (22.67 cubic feet per minute). During the tests, sample weight was recorded for each sample until a constant weight was obtained. The tests were performed as described below.

Core Preparation

A cylindrical core with a thickness of 1″ and diameter of 4.5″ was used for the testing. The cores were prepared using a phenolic urethane cold-box binder system. A KitchenAid mixer was used to prepare the cores. A batch weight of 3000 grams were used. A binder content of 1.0% based on sand weight was used, with a Part I resin:Part II resin ratio of 55:45. A Gaylord gassing chamber was used to produce the cores.

Silica sand was first split and the required weight was placed in a mixing bowl. The Part I resin was then added to the sand and mixed for 60 seconds after which the Part II resin was added and mixed for 60 seconds. The final mixture was then packed in the core box and gassed in the gassing chamber. Gassing and purging pressures of 20 psi and 40 psi respectively were used. The cores were gassed for 1 second and purged for 10 seconds.

The percent solids, permeability and wet thickness tests were conducted as per American Foundry Society (AFS) standards. A Dietert permmeter was used to measure the permeability of the coated cores. Additionally, permeability of uncoated cores was measured. A Brookfield viscometer was used to measure the viscosity of the coating, with the viscosity measured at 20 rpm using the S62 spindle.

Coating Procedure

The coatings were first mixed to obtain the required baume. Distilled water was used to lower the baume of the coatings. Comp. Ex. 1 was tested at a baume of 26-28 while Ex. 1 was tested at a baume of 35-40. Once the required baume was obtained, the cylindrical cores were dipped in the coating such that one surface of the core was completely covered by the coating. The cores were dipped for five seconds, following which, they were removed and excess coating was allowed to run out.

The coated cores were placed on a fixture in a Precision Scientific convection oven, capable of variable airflow and a maximum temperature of 500 OF. The fixture was connected to a DAQ scale, placed on top of the oven. The DAQ scale was connected to a computer using an OMEGA data acquisition system. Sample weight was acquired every 30 seconds until the coated core was dry.

Baseline Tests

The baseline results for the coatings are shown in Table 2. Comp. Ex. 1 was determined to have a solids content of 41.273%, while Ex. 1 had a slightly higher solids content of 43.416%. As mentioned above, the remaining weight percent is primarily carrier fluid, which was water in both compositions. Both coatings can be observed to have similar viscosity and wet thickness.

The permeability of the 2″×2″ cores coated with Comp. Ex. 1 and Ex. 1 coatings were determined to be 99.2 and 124.4 respectively. The permeability of the uncoated baseline cores was determined to be 161.

TABLE 2

| | Percent | Viscosity | Permeability | Wet Thickness |
|---|---|---|---|---|
| Coating | Solids | (cP) | (AFS) | (mm) |
| Comp. Ex. 1 | 41.273 | 321.8 | 99.2 | 6.6 |
| Ex. 1 | 43.416 | 334.2 | 124.4 | 7.2 |

Drying Time Results

To compare the drying time results, the percent weight loss in coating weight was calculated for each sample using the formula:

$$\frac{\begin{matrix}Weight of oated core ( initial ) - \\ Weight of coated core ( vs . time )\end{matrix}}{Weight of coated core - Weight of uncoated core} \times 100$$

As mentioned earlier, the tests were stopped when a constant weight was observed. Ten replicates were run per sample.

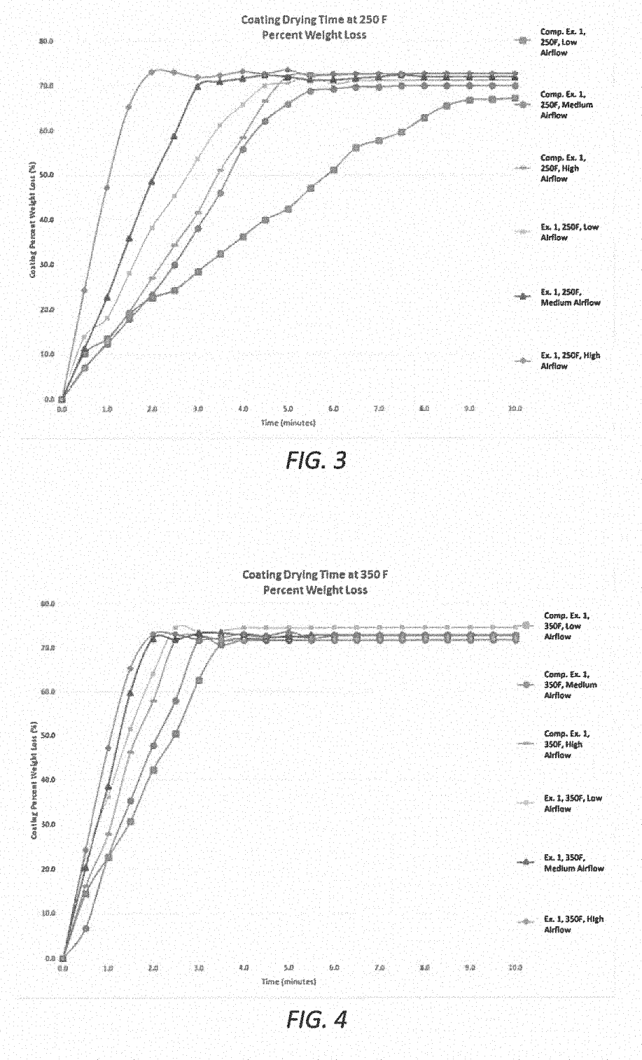

FIG. 3 shows the drying time for the coatings at 250° F. and the three airflow levels. It can be observed that Comp. Ex. 1, at a low air flow, has the longest drying time when compared to the other samples. The increased airflow, at medium and high airflow, considerably decreases the drying time of the coating. Ex. 1, shows a similar trend, with decreased drying times at higher air flow rates. Additionally, it can be observed that Ex. 1 shows a considerably shorter drying time, ranging from 3 minutes to 4.5 minutes shorter approximately, when compared to Comp. Ex. 1 across all three air flow rates.

The drying time results for the coatings at 350° F. are shown in FIG. 4. As expected, the drying times are lower when compared to a temperature of 250 F. Comparing the two coatings, a trend similar to the 250° F. temperature was observed, with the Ex. 1 having a significantly shorter drying time when compared to Comp. Ex. 1.

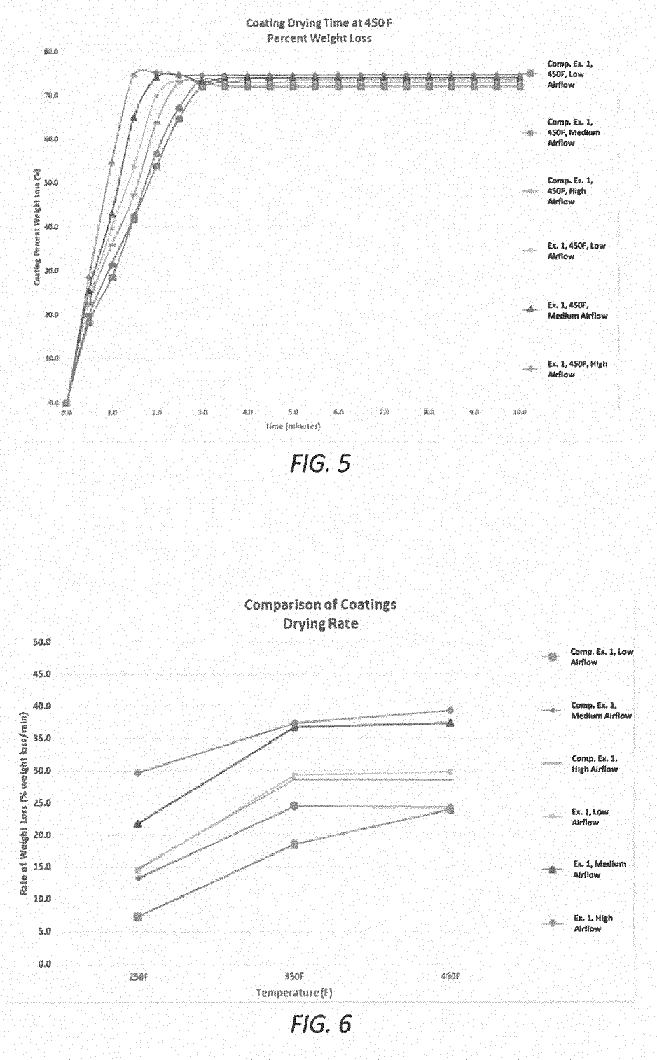

FIG. 5 shows the drying time results for both coatings at 450° F. The trend seen is very similar to the drying time at 350° F. Air flow shows a smaller change in drying time at 450° F. when compared to 250° F. Ex. 1 was observed to have shorter drying times when compared to Comp. Ex. 1.

The drying rate, that is, slopes of time (minutes) vs. coating percent weight loss (%), was calculated for all the samples, to enable numerical comparison of the coatings at different levels of the variable. FIG. 6 shows the drying rate results for all samples. From the figure, it can be observed that Ex. 1 had similar or better drying times when compared to Comp. Ex. 1. Additionally, it can be seen that adjusting the air flow from low to medium or high has a significant effect on the coating drying time.

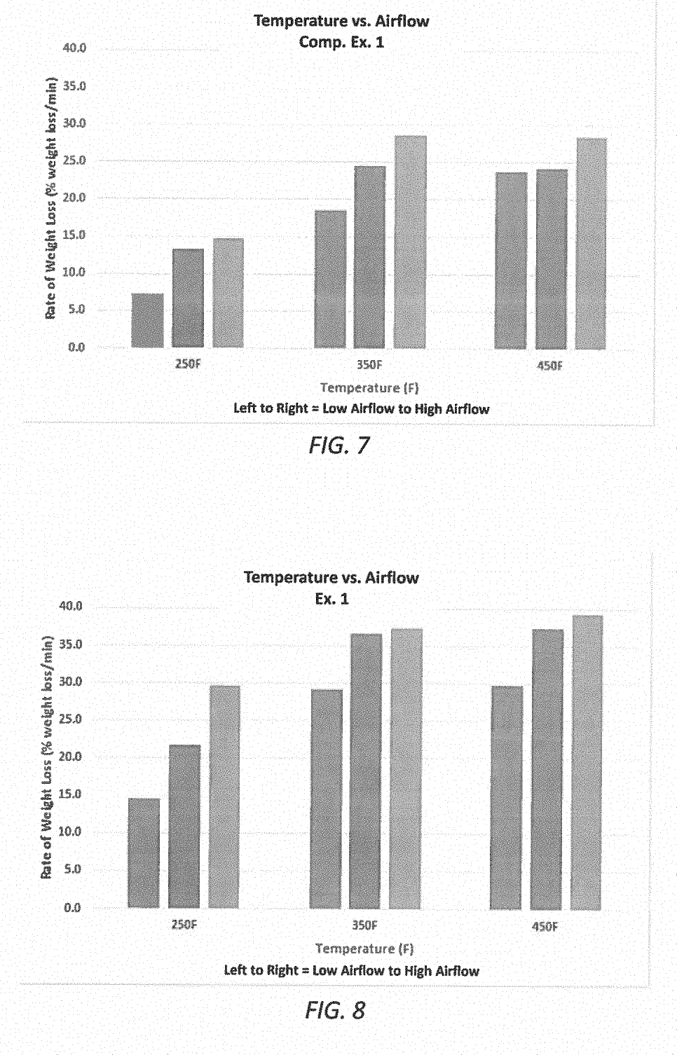

This can further be seen in FIG. 7, which shows the temperature vs. airflow results for Comp. Ex. 1. A significant increase in drying rate can be observed at 250° F. and 250° F. when the air flow is increased from low to medium or high. A smaller increase can be seen at 450° F. A similar trend can be observed for Ex. 1, shown in FIG. 8. It can also be observed that the drying rate at high airflow and 250° F. is comparable to the drying rate at low air flow at 350° F. and 450° F.

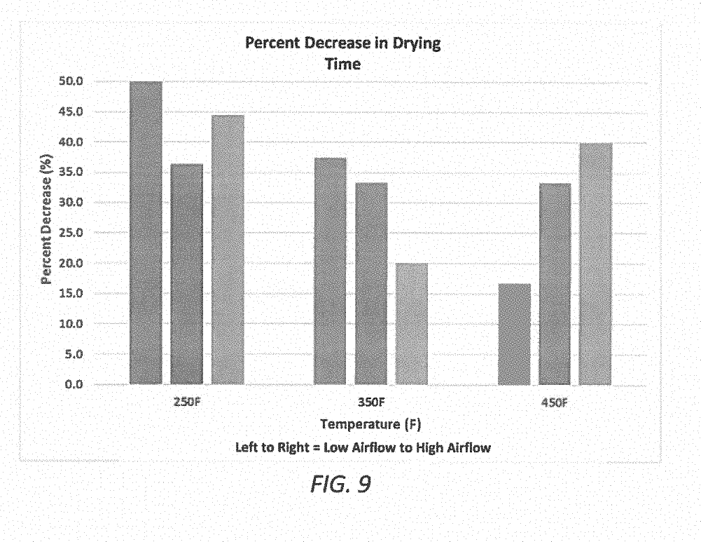

From the results discussed, it was observed that Ex. 1 had a significantly lower drying time when compared to Comp. Ex. 1. FIG. 9 shows the percent decrease in drying time for Ex. 1 when compared to Comp. Ex. 1. At 250° F., Ex. 1 was measured to have approximately 50%, 36%, and 39% shorter drying time at low, medium, and high airflow respectively, when compared to Comp. Ex. 1. The percent drying time reduction ranged from 20%-36% and 16%-40% at 350° F. and 450° F. respectively.

Although only a few example embodiments have been described in detail above, those skilled in the art will readily appreciate that many modifications are possible in the example embodiments without materially departing from this invention. Specifically, it is the express purpose of the present disclosure to potentially utilize each value present in any of the ranges referenced in the text above as a minimum or a maximum of a more narrow range not explicitly depicted. Accordingly, all such modifications are intended to be included within the scope of this disclosure as defined in the following claims.

What is claimed:

1. A refractory coating composition comprising:
a carrier liquid; and
solid ceramic beads.

2. The composition of claim 1, wherein the ceramic beads have a D₉₅ value in the range from about 75 microns to 150 microns, a D₅₀ value in the range from about 35 microns to 50 microns, and a D₁₀ value in the range from about 5 microns to 15 microns.

3. The composition of claim 1, wherein the ceramic beads comprise alumina, silica, magnesia, zirconia, calcium oxide, tungsten carbide, boron nitride, and/or hafnium carbide.

4. The composition of claim 1, wherein the ceramic beads consist essentially of fused alumina.

5. The composition of claim 4, wherein the fused alumina comprises:
about 50-85% by weight alumina;
about 5-30% by weight silica;
about 1-15% by weight titania; and
about 1-12% by weight iron oxide (Fe₂O₃);
wherein a total of the amount is 100% by weight.

6. The composition of claim 5, further comprising:
about 0.1-5% by weight potassium oxide;
about 0.05-2% by weight calcium oxide; and
about 0.05-1.5% by weight copper oxide (CuO).

7. The composition of claim 1, wherein the ceramic beads do not sinter or melt at temperatures below about 1500° C.

8. The composition of claim 1, wherein the ceramic beads have a hardness of at least 7 on the Mohs scale.

9. The composition of claim 1, wherein the composition comprises:
30-80% by weight ceramic beads; and
15-50% by weight carrier fluid.

10. The composition of claim 1, further comprising:
one or more selected from rheological modifiers, viscosifiers, chelating agents, dispersants, binders, foam control agents, a carbon additive, surfactants, wetting agents, and preservatives.

11. The composition of claim 1, wherein the ceramic beads have a pH value between about 6.5 and 7.5.

12. A refractory coating composition comprising:
a carrier liquid; and
about 40-80% by weight ceramic beads.

13. The composition of claim 12, wherein the ceramic beads are solid.

14. The composition of claim 12, wherein the ceramic beads have a D₉₅ value in the range from about 75 microns to 150 microns, a D₅₀ value in the range from about 35 microns to 50 microns, and a Duo value in the range from about 5 microns to 15 microns.

15. The composition of claim 12, wherein the ceramic beads comprise alumina, silica, magnesia, zirconia, calcium oxide, tungsten carbide, boron nitride, and/or hafnium carbide.

16. The composition of claim 12, wherein the ceramic beads consist essentially of a fused alumina.

17. The composition of claim 16, wherein the fused alumina comprises:
about 50-85% by weight alumina;
about 5-30% by weight silica;
about 1-15% by weight titania; and
about 1-12% by weight iron oxide (Fe₂O₃);
wherein a total of the amount is 100% by weight.

18. The composition of claim 17, further comprising:
about 0.1-5% by weight potassium oxide;
about 0.05-2% by weight calcium oxide; and
about 0.05-1.5% by weight copper oxide (CuO).

19. The composition of claim 12, wherein the ceramic beads have a hardness of at least 7 on the Mohs scale.

20. The composition of claim 12, wherein the amount of carrier fluid in the composition is in the range from about 15-50/o by weight.

21. A refractory coating composition, comprising:
15-50% by weight carrier fluid;
30-80% by weight solid ceramic beads;
2.5-12% by weight graphite;
0.25-6% by weight clay; and
0.1-1% binder.

22. A method of coating a substrate with a refractory coating composition, comprising:
applying a refractory coating composition according to claim 21 to a substrate; and
drying the refractory coating composition.

23. The method of claim 22, further comprising:
diluting the refractory coating composition.

24. The method of claim 22, wherein the drying takes at least 5% less time than a comparable traditional refractory coating composition.

25. A method of casting a metal, comprising:
forming and binding a substrate body;
coating the substrate body with a refractory coating composition according to claim 21;
drying the refractory coating composition onto the substrate body to form a coated substrate body;
casting a molten metal onto the coated substrate body; and
separating a metal casting from the coated substrate body.

26. A method of centrifugally casting a metal, comprising:
coating the interior of a centrifugal mold with a refractory coating composition comprising:
a carrier liquid; and
about 60-80% by weight ceramic beads;
drying the refractory coating composition onto the centrifugal mold;
centrifugally casting a molten metal into the centrifugal mold body; and
separating a metal casting from the centrifugal mold body.
